(19) United States
(12) Patent Application Publication
(10) Pub. No.: US 2024/0093331 A1
(43) Pub. Date: Mar. 21, 2024

(54) METHOD FOR RECYCLING ALUMINUM ALLOY SCRAP

(71) Applicant: The Boeing Company, Arlington, VA (US)

(72) Inventors: Zhi Sun, Beijing (CN); Chunwei Liu, Beijing (CN); Guoyu Qian, Beijing (CN); Zhi Wang, Beijing (CN); Hongbin Cao, Beijing (CN); Pengcheng Yan, Beijing (CN)

(73) Assignee: The Boeing Company, Arlington, VA (US)

(21) Appl. No.: 18/261,715

(22) PCT Filed: Mar. 4, 2022
(86) PCT No.: PCT/US2022/018836

§ 371 Date: Jul. 17, 2023

(30) Foreign Application Priority Data
May 14, 2021 (CN) 202110529048.1

(51) Int. Cl. C22C 1/02; B22D 21/00; C22B 1/02; C22B 1/248; C22B 7/00; C22B 21/00; C22C 1/03; C22C 21/10; C22C 21/14; C22C 21/16; C22C 21/18

(52) U.S. Cl. CPC C22C 1/026; B22D 21/007; C22B 1/02; C22B 1/248; C22B 7/001; C22B 21/0007; C22B 21/0092; C22C 1/03; C22C 21/10; C22C 21/14; C22C 21/16; C22C 21/18

(57) ABSTRACT

A method for recycling an aluminum alloy scrap includes performing selective oxidation roasting and washing treatment on the aluminum alloy scrap to obtain an uncoated aluminum alloy scrap; melting the uncoated aluminum alloy scrap in a refining furnace to obtain aluminum alloy melt liquid, online-detecting components of the aluminum alloy melt liquid and adding a metallic copper, a copper alloy, a magnesium alloy or a zinc alloy to the aluminum alloy melt liquid according to the requirements of target alloy components, performing pressure-controlled and oxygen-controlled melting through regulating pressure intensity and oxygen partial pressure in the refining furnace and coupling an external-field stirring mode to obtain refining aluminum alloy melt liquid; filtering the refining aluminum alloy melt liquid, to obtain an aluminum alloy melt with the target alloy components; and casting the aluminum alloy melt.

### PRIORITY

This application claims priority from Chinese Pat. App. No. 202110529048.1 filed on May 14, 2021.

### FIELD

The present disclosure relates generally to the field of comprehensive utilization of resources of “urban mines” and environmental protection, and, more particularly, to a method for recycling aluminum alloy materials.

### BACKGROUND

Aluminum alloy has become the second largest metal material in the world due to a series of excellent properties thereof, such as high strength, low density and corrosion resistance and the like. Along with the rapid development of global economy, the production of primary aluminum worldwide is rapidly increased. It is shown from data that the production of the primary aluminum in the world is 63.4 million tons in 2017. From the 1920s to the beginning of the twenty-first century, a mass ratio of aluminum alloy parts in airplane materials reaches 75%-80% of the total mass.

Compared with the production of the primary aluminum, the use of secondary aluminum resources to produce and regenerate aluminum not only saves bauxite resources, but also significantly reduces energy consumption. It thus has the positive effects of alleviating energy crisis and reducing environmental burden. However, there may be challenges when using aluminum alloy, including when the content of the alloy component is high and the composition is complicated. At present, the technical difficulty to be solved when regenerating and preparing the aluminum alloy is to achieve precise and efficient control of alloy components such as zinc, copper and magnesium and the like during a melting process.

Accordingly, those skilled in the art continue with research and development efforts in the field of recycling and, as such, methods for recycling aluminum alloy materials.

### SUMMARY

The following is a non-exhaustive list of examples, which may or may not be claimed, of the subject matter according to the present disclosure.

Disclosed are methods for recycling aluminum alloy scrap.

In an example, the method includes performing selective oxidation roasting and washing treatment on the aluminum alloy scrap, thereby paint-removing and oil-removing to obtain an uncoated aluminum alloy scrap. The method further includes melting the uncoated aluminum alloy scrap in a refining furnace to obtain aluminum alloy melt liquid, online-detecting components of the aluminum alloy melt liquid, and adding a metallic copper, a copper alloy, a magnesium alloy or a zinc alloy to the aluminum alloy melt liquid according to the requirements of target alloy components, performing pressure-controlled and oxygen-controlled melting through regulating pressure intensity and oxygen partial pressure in the refining furnace and coupling an external-field stirring mode, to obtain refining aluminum alloy melt liquid. The method further includes condensing and liquefying volatile elements volatilized in a pressure-controlled and oxygen-controlled melting process to separate from the refining aluminum alloy melt liquid, in the absence of volatile elements, eliminating the condensing and liquefying step. The method further includes filtering the refining aluminum alloy melt liquid, to obtain an aluminum alloy melt with the target alloy components. The method further includes casting the aluminum alloy melt.

In another example, the method includes selective oxidation roasting the aluminum alloy scrap, washing the aluminum alloy scrap to yield an uncoated aluminum alloy scrap, melting the uncoated aluminum alloy scrap in a refining furnace to yield an aluminum alloy melt liquid, online-detecting components of the aluminum alloy melt liquid, adding one or more of metallic copper, copper alloy, magnesium alloy, and zinc alloy to the aluminum alloy melt liquid, pressure-controlled and oxygen-controlled melting the aluminum alloy melt liquid to yield refining aluminum alloy melt liquid, filtering the refining aluminum alloy melt liquid to yield an aluminum alloy melt, and casting the aluminum alloy melt.

Other examples of the disclosed systems, apparatuses, and methods will become apparent from the following detailed description, the accompanying drawings, and the appended claims.

### BRIEF DESCRIPTION OF THE DRAWING

FIG. 1 is an overall process flow diagram of one embodiment according to the present disclosure.

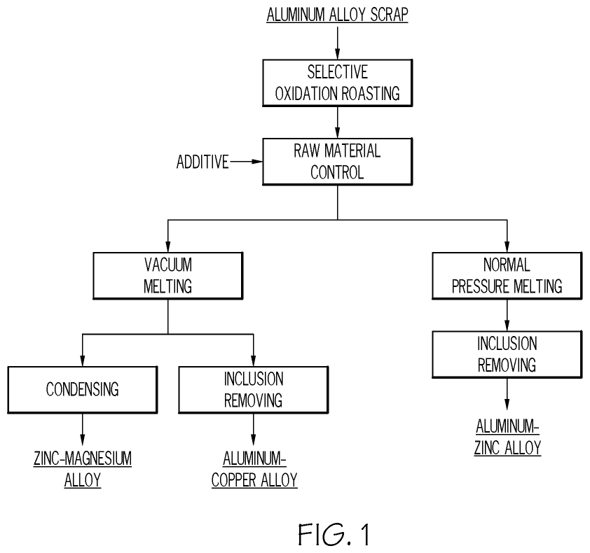

### DETAILED DESCRIPTION

One goal of the present disclosure is to provide a method for recycling an aluminum alloy scrap, so as to solve a problem in a prior art that it is difficult to achieve the precise and efficient control of alloy components such as zinc, copper and magnesium and the like in the aluminum alloy scrap.

In order to achieve the above purpose, according to the present disclosure, a method for recycling an aluminum alloy scrap is provided, the method comprises the following steps: performing selective oxidation roasting and washing treatment on the aluminum alloy scrap, thereby paint-removing and oil-removing to obtain an uncoated aluminum alloy scrap; melting the uncoated aluminum alloy scrap in a refining furnace to obtain aluminum alloy melt liquid, online-detecting components of the aluminum alloy melt liquid, and adding a metallic copper, a copper alloy, a magnesium alloy or a zinc alloy to the aluminum alloy melt liquid according to the requirements of target alloy components, performing pressure-controlled and oxygen-controlled melting through regulating pressure intensity and oxygen partial pressure in the refining furnace and coupling an external-field stirring mode, to obtain refining aluminum alloy melt liquid; condensing and liquefying volatile elements volatilized in a pressure-controlled and oxygen-controlled melting process to separate from the refining aluminum alloy melt liquid, in the absence of volatile elements, eliminating the condensing and liquefying step; filtering the refining aluminum alloy melt liquid, to obtain an aluminum alloy melt with the target alloy components; and casting the aluminum alloy melt.

Further, the aluminum alloy scrap comprises aluminum alloy sweeps, aluminum alloy cutting remainders or a mixture of them, and the method further comprises performing briquetting treatment on the uncoated aluminum alloy scrap before melting the uncoated aluminum alloy scrap.

Further, the method further comprises adding molten salt according to the requirements of the target alloy components in the pressure-controlled and oxygen-controlled melting process.

Further, a source of the aluminum alloy scrap comprises an aluminum alloy processing scrap or a waste product disassembled aluminum alloy scrap, preferably, the aluminum alloy scrap is one or more of a 2-series aluminum alloy scrap and a 7-series aluminum alloy scrap, and preferably, the aluminum alloy scrap is a mixed scrap formed of one or more of the 2-series aluminum alloy scrap and one or more of the 7-series aluminum alloy scrap.

Further, in no less than 10 vol % of oxygen concentration, the selective oxidation roasting is performed.

Further, in the selective oxidation roasting process, the roasting temperature is controlled within a range from 200° C. to 600° C. and the roasting time is controlled within a range of 10-180 min.

Further, the briquetting treatment of the uncoated aluminum alloy scrap is performed by using a briquetting machine and selecting a pressing pressure intensity and a pressing time, preferably, the pressing pressure intensity is controlled within a range of 10-100 MPa, and the pressing time is controlled within a range of 1-100 min.

Further, the refining furnace is a vacuum resistance furnace, a vacuum induction furnace or a normal pressure intermediate frequency furnace, preferably, in the case that a target alloy is a 2-series aluminum alloy, the refining furnace is the vacuum induction furnace, and in the case that the target alloy is a 7-series aluminum alloy, the refining furnace is the normal pressure intermediate frequency furnace, more preferably, in the pressure-controlled and oxygen-controlled melting process, the pressure intensity in the vacuum induction furnace is controlled to not more than 50 Pa and the oxygen partial pressure in the vacuum induction furnace is controlled to not more than 0.0001 Pa.

Further, in the pressure-controlled and oxygen-controlled melting process, the melting temperature is controlled within a range of 700-1250° C. and the melting time is controlled within a range of 10-640 min.

Further, the external-field stirring mode is electromagnetic stirring or air-blowing stirring.

By applying the technical scheme of the present disclosure, through performing the selective oxidation roasting and washing treatment on the aluminum alloy scrap, the paint and oil may be efficiently removed in mild conditions and simple operations and burning loss of the aluminum alloy is avoided; through the pressure-controlled and oxygen-controlled melting, the alloy components in the aluminum alloy scrap may be adequately utilized, the contents of the components such as zinc, copper and magnesium and the like in the aluminum alloy scrap may be accurately and efficiently controlled, and the aluminum alloy meeting the requirements of the industry components is regenerated and prepared; through the condensing and liquefying step, the volatile elements volatilized are recycled in an alloy form, not only the cost is saved, but also the environment is avoided from being harmed by potentially volatile matter. Therefore, the method for recycling the aluminum alloy scrap of the present disclosure achieves the precise and efficient control of the components such as zinc, copper and magnesium and the like in the aluminum alloy scrap through a short-range melting process, and is capable of adequately utilizing the alloy components in the aluminum alloy scrap in the high metal yield, thereby regenerating and preparing the aluminum alloy meeting the requirements of the industry components.

It is to be noted that embodiments in the present application and features in the embodiments may be mutually combined in the case without conflicting. The present disclosure is described in detail below in combination with the embodiments.

As described in the background art, it is difficult to achieve the precise and efficient control of alloy components such as zinc, copper and magnesium and the like in the aluminum alloy scrap in the prior art. In order to solve the problem, the present application provides a method for recycling an aluminum alloy scrap, the method comprises the following steps: performing selective oxidation roasting and washing treatment on the aluminum alloy scrap, thereby paint-removing and oil-removing to obtain an uncoated aluminum alloy scrap; melting the uncoated aluminum alloy scrap in a refining furnace to obtain aluminum alloy melt liquid, online-detecting components of the aluminum alloy melt liquid, and adding a metallic copper, a copper alloy, a magnesium alloy or a zinc alloy to the aluminum alloy melt liquid according to the requirements of target alloy components, performing pressure-controlled and oxygen-controlled melting through regulating pressure intensity and oxygen partial pressure in the refining furnace and coupling an external-field stirring mode, to obtain refining aluminum alloy melt liquid; condensing and liquefying volatile elements volatilized in a pressure-controlled and oxygen-controlled melting process so as to separate from the refining aluminum alloy melt liquid, in the absence of volatile elements, eliminating the condensing and liquefying step; filtering the refining aluminum alloy melt liquid, to obtain an aluminum alloy melt with the target alloy components; and casting the aluminum alloy melt.

The aluminum alloy scrap in this application may include aeronautical aluminum alloy scrap. Preferably, the aluminum alloy scrap may be aeronautical aluminum alloy scrap. The aluminum alloy scrap in this application may include one or more of a 2-series aluminum alloy scrap and a 7-series aluminum alloy scrap. Through the method for recycling the aluminum alloy scrap of the present disclosure, the aluminum alloy meeting the requirements of the industry components, especially aeronautical aluminum alloy meeting the requirements of the aeronautical industry components can be regenerated and prepared in a high metal yield.

In the present application, meeting the requirements of the industry components of aluminum alloy refers to meeting component requirements of a specific aluminum alloy, such as 2-series aluminum alloy such as a 2024-Al alloy or 7-series aluminum alloy such as a 7075-Al alloy and the like, specified in “GB/T3190-2008 wrought aluminum and aluminum alloy chemical components”. The main alloy components of the 2-series aluminum alloy are copper and magnesium, and the main alloy components of the 7-series aluminum alloy are zinc, magnesium and copper.

In the present application, a purpose of performing the selective oxidation roasting on the aluminum alloy scrap is to oxidize only a paint layer and an oil layer on the surface of the aluminum alloy scrap, but not to oxidize the alloy components of the aluminum alloy scrap body.

The washing treatment may be performed on the aluminum alloy scrap by using the conventional washing methods in the art. In order to ensure the efficient removal of the paint and the oil from the aluminum alloy scrap, the washing treatment may be performed on the aluminum alloy scrap by the following steps: using 1-10 wt % of hydrochloric acid for washing once the aluminum alloy scrap after the selective oxidation roasting at 30-80° C. and under an ultrasonic condition for 5-60 min, then washing an obtained aluminum alloy scrap by high purity water for 10-60 min at a room temperature.

In a process of adding the metallic copper, the copper alloy, the magnesium alloy or the zinc alloy to the aluminum alloy melt liquid according to the requirements of the target alloy components, an addition amount of these metal or alloys is determined by a difference between the actually detected components of the aluminum alloy melt liquid and the target alloy components. It is assumed that the online-detected content of a certain component in the aluminum alloy melt liquid is X wt %, and the average content of the component in the target alloy is required to be Y wt %, if X wt % is less than Y wt %, a weight percentage of the metal or alloys of the to-be-added component relative to the aluminum alloy scrap may be calculated according to the difference value between Y wt % and X wt %; and if X wt % is greater than Y wt %, suitable removal of the component may be achieved by controlling the melting conditions. Through the dynamic regulation of the components, the melted alloy is guaranteed to meet the component requirements of the target alloy.

The volatile elements volatilized in a melting process of the aluminum alloy mainly include zinc and magnesium and the like. The presence or absence of the volatile elements may be determined based on the detected composition of the aluminum alloy melt liquid. In the absence of the volatile elements, the condensing and liquefying step may be eliminated.

The present application may, through performing the selective oxidation roasting and washing treatment on the aluminum alloy scrap, efficiently remove the paint and the oil in the mild conditions and the simple operations and avoid the burning loss of the aluminum alloy; through the pressure-controlled and oxygen-controlled melting, adequately utilize the alloy components in the aluminum alloy scrap, accurately and efficiently control the contents of the components such as zinc, copper and magnesium and the like in the aluminum alloy scrap, and regenerate and prepare the aluminum alloy meeting the requirements of the industry components; through the condensing and liquefying step, recycle the volatile elements volatilized in the alloy form, not only save the cost, but also avoid the environment from being harmed by potentially volatile matter. Therefore, the method for recycling the aluminum alloy scrap of the present disclosure achieves the precise and efficient control of the components such as zinc, copper and magnesium and the like in the aluminum alloy scrap through a short-range melting process, and is capable of adequately utilizing the alloy components in the aluminum alloy scrap in the high metal yield, thereby regenerating and preparing the aluminum alloy meeting the requirements of the industry components.

A source of the aluminum alloy scrap of the present disclosure includes an aluminum alloy processing scrap or a waste product disassembled aluminum alloy scrap, the waste product disassembled aluminum alloy scrap is for example waste airplane disassembled aluminum alloy scrap. The aluminum alloy scrap of the present disclosure may be one of a 2-series aluminum alloy scrap and a 7-series aluminum alloy scrap or a mixed scrap of more of them. The aluminum alloy scrap may be the mixed scrap formed by mixing one or more of the 2-series aluminum alloy scrap and one or more of the 7-series aluminum alloy scrap in arbitrary proportions.

In allusion to features of components of the mixed scrap of the 2-series aluminum alloy and the 7-series aluminum alloy, the present disclosure, through modes of selective oxidation roasting, pressure-controlled and oxygen-controlled melting, alloying, condensing, non-metallic inclusion separating and casting, finally achieves the regeneration and preparation of the 2-series aluminum alloy or the 7-series aluminum alloy from the mixed scrap of the 2-series aluminum alloy and the 7-series aluminum alloy.

The method for recycling the aluminum alloy scrap of the present disclosure may further comprise adding molten salt according to the requirements of the target alloy components in the pressure-controlled and oxygen-controlled melting process. For example, 35% NaCl-35% KCl-30% AlCl3 (w/w) or 45% NaCl-45% KCl-10% AlCl3 (w/w) may be used as the molten salt. Through adding the molten salt, oxidation on the surface of the melt may be reduced so as to improve a recycling rate of the aluminum alloy scrap, and the alloy components may be fine-regulated.

Selective oxidation roasting may be performed in no less than 10 vol % of oxygen concentration. Through adopting the above oxygen concentration, it may be guaranteed that the paint and the oil are removed from the aluminum alloy scrap to obtain an uncoated aluminum alloy scrap, thereby avoiding impurity elements (such as chromium, barium and strontium and the like) in a coating layer from entering the melting process so that the regenerated and prepared aluminum alloy is not up to a standard in components. If the oxygen concentration is less than 10 vol %, the paint layer and the oil layer on the surface of the aluminum alloy scrap may not be adequately oxidized, therefore, it may not be guaranteed that the paint and the oil are completely removed from the aluminum alloy scrap to obtain the uncoated aluminum alloy scrap, and it is caused that the regenerated and prepared aluminum alloy is not up to the standard in components. Preferably, the oxygen concentration in the selective oxidation roasting process may be in the range of 10 vol % to 25 vol %.

The selective oxidation roasting may be performed in a roasting furnace, the roasting furnace used may be a resistance furnace or an induction furnace, preferably, the oxidation roasting treatment may be performed by using the resistance furnace.

In order to better promote the paint layer and the oil layer of the aluminum alloy scrap to be peeled from the substrate of the aluminum alloy scrap and avoid the over oxidation damage of the aluminum alloy scrap, the roasting temperature in the selective oxidation roasting process may be controlled within a range of 200° C. to 600° C. For example, the roasting temperature may be 200° C., 300° C., 400° C., 500° C. or 600° C. and the like.

The roasting time in the selective oxidation roasting process may be controlled within a range of 10-180 min. For example, the roasting time may be 20 min, 50 min, 80 min, 120 min, 150 min or 180 min and the like. Through controlling the roasting time within the above range, it may be guaranteed that the paint and the oil are adequately removed from the aluminum alloy scrap to obtain the uncoated aluminum alloy scrap, and the loss of the aluminum alloy body is avoided as much as possible.

Through regulating roasting temperature and roasting time in the selective oxidation roasting process, the paint layer and the oil layer of the aluminum alloy scrap may be promoted to be peeled from a substrate of the aluminum alloy scrap, and an over oxidation damage of the aluminum alloy scrap may be avoided.

If the aluminum alloy scrap contains materials in forms of aluminum alloy sweeps, aluminum alloy cutting remainders or a mixture of them and the like, the method of the present disclosure further includes performing briquetting treatment on the uncoated aluminum alloy scrap before melting the uncoated aluminum alloy scrap. Through performing the briquetting treatment on the uncoated aluminum alloy scrap, a compacted aluminum alloy block may be obtained, the utilization efficiency of the melting furnace is improved and the recycling rate of the aluminum alloy scrap is greatly improved.

The briquetting treatment of the uncoated aluminum alloy scrap may be performed by using a briquetting machine for example an ordinary briquetting machine under a certain pressing pressure intensity and a certain pressing time. The pressing pressure intensity may be controlled within a range of 10-100 MPa. For example, the pressing pressure intensity may be 10 MPa, 30 MPa, 50 MPa or 100 MPa and the like. The pressing time may be controlled within a range of 1-100 min. For example, the pressing time may be 1 min, 5 min, 10 min, 50 min or 80 min and the like. Through the above way, the apparent density of the aluminum alloy scrap may be improved, an utilization ratio of the refining furnace may be increased, and the recycling rate of the aluminum alloy scrap may be greatly improved.

In one embodiment of the present disclosure, the method for recycling the aluminum alloy scrap includes the following steps.

The method includes selective oxidation roasting: the selective oxidation roasting and washing treatment is performed on the aluminum alloy scrap, the paint and the oil are removed, and the oxidation of the aluminum alloy body is minimized, to obtain the uncoated aluminum alloy scrap.

The method further includes pressure-controlled and oxygen-controlled melting: the uncoated aluminum alloy scrap is melted in the refining furnace after the briquetting treatment (if the sweeps and the cutting remainders do not exist, the briquetting treatment may not be performed), optionally, the different types of the molten salt are added according to the requirements of the target alloy components, the components of the aluminum alloy melt liquid are online-detected, and a metallic copper or a copper alloy, a magnesium alloy or a zinc alloy and the like are added to the aluminum alloy melt liquid in a certain adding mode according to the requirements of the target alloy components, inclusion removal and alloy homogenization are enhanced to perform the pressure-controlled and oxygen-controlled melting through regulating the pressure intensity and the oxygen partial pressure in the refining furnace and coupling an external-field stirring mode, to obtain refining aluminum alloy melt liquid.

The method further includes condensing: volatile elements volatilized in a pressure-controlled and oxygen-controlled melting process are condensed and liquefied on a condensing plate installed above the refining aluminum alloy melt liquid to separate from the refining aluminum alloy melt liquid, if the volatile elements do not exist, the step may be eliminated.

The method further includes inclusion separating: the refining aluminum alloy melt liquid is filtered by using a filter such as a ceramic filter to remove inclusions, and an aluminum alloy melt with the target alloy components is obtained.

The method further includes casting the aluminum alloy melt is casted.

In the method for recycling the aluminum alloy scrap of the present disclosure, the refining furnace used in the pressure-controlled and oxygen-controlled melting may be a vacuum resistance furnace, a vacuum induction furnace or a normal pressure intermediate frequency furnace. Preferably, in the case that the target alloy is the 2-series aluminum alloy, the vacuum induction furnace may be used to achieve the alloy homogenization. More preferably, in the pressure-controlled and oxygen-controlled melting process, the pressure intensity in the vacuum induction furnace may be controlled to not more than 50 Pa and the oxygen partial pressure in the vacuum induction furnace may be controlled to not more than 0.0001 Pa. In the case that the target alloy is the 7-series aluminum alloy, the normal pressure intermediate frequency furnace (normal pressure ordinary oxygen partial pressure) may be used to achieve the alloy homogenization.

The melting temperature in the pressure-controlled and oxygen-controlled melting process may be controlled within a range of 700-1250° C., to melt the aluminum alloy. For example, the melting temperature in the pressure-controlled and oxygen-controlled melting process may be 750° C., 850° C., 1000° C. or 1200° C. and the like.

The melting time in the pressure-controlled and oxygen-controlled melting process may be controlled within a range of 10-640 min. For example, the melting time in the pressure-controlled and oxygen-controlled melting process may be 20 min, 50 min, 100 min, 300 min or 500 min and the like. When the aluminum alloy sweeps or the aluminum alloy cutting remainders are used as a raw material, in order to reduce the burning loss of the aluminum alloy, the melting time may be controlled within 60 min.

The external-field stirring mode in the pressure-controlled and oxygen-controlled melting process may be electromagnetic stirring or air-blowing stirring. Preferably, the external-field stirring mode in the pressure-controlled and oxygen-controlled melting process may adopt the electromagnetic stirring. Through the above mode, melting dynamic conditions may be improved, and upward floating of the inclusions is accelerated, it is convenient to remove the inclusions.

In a preferable embodiment of the present disclosure, a method for high-valued preparation of a 2-series aluminum alloy or a 7-series aluminum alloy from a mixed scrap of the 2-series aluminum alloy and the 7-series aluminum alloy includes the following steps:
(1) Selective oxidation roasting is performed on the mixed scrap of the 2-series aluminum alloy and the 7-series aluminum alloy in no less than 10 vol % of oxygen concentration, a roasting temperature is 350-550° C., roasting time is 60-180 min, and then 1-10% (w/w) of hydrochloric acid is used for washing once for 5-60 min at 30-80° C. and under an ultrasonic condition, an obtained scrap is washed by high purity water for 10-60 min at a room temperature, to obtain an uncoated aluminum alloy scrap without paint and oil.
(2) If the aluminum alloy scrap contains aluminum alloy sweeps, aluminum alloy cutting remainders or a mixture of them, briquetting treatment is performed on the aluminum alloy scrap for 1-20 min under 10-60 MPa of pressing pressure intensity (if the aluminum alloy sweeps, the aluminum alloy cutting remainders or a mixture of them do not exist, the briquetting treatment may not performed); a block-shaped material after the briquetting treatment is put into a vacuum induction furnace or a normal pressure intermediate frequency furnace for melting; components of aluminum alloy melt liquid are online-detected by using a spectrometer, according to the requirements of the target alloy components, a metallic copper, a copper alloy, a magnesium alloy or a zinc alloy and the like are added to the aluminum alloy melt liquid, and melting is performed for 30-120 min at a temperature of 800-1000° C., reaction time is determined by an adding amount of materials, and along with the increase of the adding amount of the materials, melting time is correspondingly prolonged; if the vacuum induction furnace is used, during the pressure-controlled and oxygen-controlled melting process, the pressure intensity in the vacuum induction furnace may be controlled to not more than 30 Pa and the oxygen partial pressure in the vacuum induction furnace may be controlled to not more than 0.0001 Pa, if the normal pressure intermediate frequency furnace is adopted, a normal pressure ordinary oxygen partial pressure may be used; and through a magnetic field stirring mode, the non-metallic inclusions are enriched to a liquid level of the aluminum alloy melt liquid to enhance the removal of the inclusions.
(3) The volatile elements such as zinc and magnesium and the like volatilized in the alloy melting process are condensed and liquefied after encountering with a graphite condensing plate above the melt liquid, and separated from refining aluminum alloy melt liquid (if the volatile elements do not exist, the step may be eliminated).
(4) The refining aluminum alloy melt liquid is filtered by using a filter such as a ceramic foam filter, to remove a magnesium oxide, an aluminum oxide, a silicon oxide and the like generated by oxidation in an operation process.
(5) A semi-continuous casting machine is used for casting, to obtain a casting ingot with fine crystal grains.

Compared with the prior art, the method for recycling the aluminum alloy scrap of the present disclosure has the following beneficial effects.

The used paint-removing and oil-removing process is simple in operation, more mild in conditions, and high in treatment efficiency, avoids the burning loss of the aluminum alloy, easy to achieve an industrialized application, and has a high use value.

In the pressure-controlled and oxygen-controlled melting process, through modes of regulating the pressure intensity and the oxygen partial pressure in the refining furnace and coupling the external-field stirring and the like, synchronous aluminum alloy impurity removing and alloying is achieved, and the high alloy components in the aluminum alloy scrap are adequately utilized, the prepared aluminum alloy may meet the requirements of the key alloy components of the aluminum alloy for the industry.

The volatile elements volatilized in the recycling process are recycled in the alloy form after being condensed, not only the recycling cost is saved, but also the surrounding environment is avoided from being harmed by the potentially volatile matter.

The metal yield is high, the aluminum loss is avoided, the alloy components in the aluminum alloy scrap may be adequately used to regenerate and prepare the aluminum alloy meeting the requirements of the industry components, and the technical economic value is improved.

In the case that the aluminum alloy scrap contains the aluminum alloy sweeps, the aluminum alloy cutting remainders or the mixture of them, through performing the briquetting treatment on the uncoated aluminum alloy scrap before melting the uncoated aluminum alloy scrap, the utilization efficiency of the refining furnace may be improved and the recycling rate of the aluminum alloy scrap is greatly improved.

In another example, the method includes selective oxidation roasting the aluminum alloy scrap, washing the aluminum alloy scrap to yield an uncoated aluminum alloy scrap, melting the uncoated aluminum alloy scrap in a refining furnace to yield an aluminum alloy melt liquid, online-detecting components of the aluminum alloy melt liquid, adding one or more of metallic copper, copper alloy, magnesium alloy, and zinc alloy to the aluminum alloy melt liquid, pressure-controlled and oxygen-controlled melting the aluminum alloy melt liquid to yield refining aluminum alloy melt liquid, filtering the refining aluminum alloy melt liquid to yield an aluminum alloy melt, and casting the aluminum alloy melt.

In order to better describe the method of the present disclosure, and conveniently understand the technical solution involved in the present disclosure, the present disclosure is further described below in combination with examples and comparative examples, but the present disclosure is not limited to the following examples only.

### Example 1

A suitable amount of 2-series and 7-series aluminum alloy processing sweeps are taken for roasting in the air (oxygen concentration is 21 vol %), a roasting temperature is 450° C., roasting time is 80 min, and 3% (w/w) of hydrochloric acid is used for washing once for 30 min at 50° C. and under an ultrasonic condition, obtained sweeps are washed for 30 min by high purity water at a room temperature, to obtain the aluminum alloy scrap without paint and oil.

Briquetting treatment is performed on the scrap for 5 min at 30 MPa, a block-shaped material is put into a vacuum induction furnace, and rapidly melted, and a spectrometer is used for online-detecting components of aluminum alloy melt liquid, a specific detection result is as shown in Table 1. According to the requirements of the target 2024 aluminum alloy components, a pure copper of which a mass fraction is 3.0% (relative to the aluminum alloy scrap) is weighed, added to the aluminum alloy melt liquid, and melted in a condition of 950° C., the vacuum induction furnace is vacuumized until the internal pressure intensity is less than 25 Pa and the oxygen partial pressure is less than 0.00005 Pa, the electromagnetic induction is used for performing electromagnetic stirring on the melt liquid, a melting dynamic condition is improved, and upward floating of inclusions is accelerated. Zinc and magnesium volatilized in the melting process are liquefied after encountering with a graphite condensing plate above the melt liquid.

After 60 min, a ceramic foam filter is used for filtering the aluminum alloy melt liquid, and then a semi-continuous casting machine is used for casting, to obtain a casting ingot. Chemical components of the casting ingot are detected by ICP-OES, a detection result is as shown in Table 1, and meets the requirements of the 2024 aluminum alloy components in “GB/T3190-2008 wrought aluminum and aluminum alloy chemical components”. Through comparing aluminum alloy weights before and after melting, it is proved that a metal yield is no less than 99%.

TABLE 1
Components of aluminum alloy mixed scrap, regenerated 2024
aluminum alloy and 2024 aluminum alloy (weight percentage)

| | Cu | Zn | Mg | Mn | Cr | Si | Fe |
|---|---|---|---|---|---|---|---|
| Original | 1.52 | 3.17 | 3.25 | 0.47 | 0.06 | 0.40 | 0.34 |
| components | | | | | | | |
| Final | 3.98 | 0.14 | 1.56 | 0.46 | 0.06 | 0.39 | 0.34 |
| components | | | | | | | |
| 2024-Al | 3.80- | <0.25 | 1.20- | 0.30- | <0.10 | <0.50 | <0.50 |
| | 4.90 | | 1.80 | 0.90 | | | |

### Example 2

A suitable amount of an aluminum alloy block-shaped material of a waste airplane is taken for roasting, oxygen concentration is 15 vol %, a roasting temperature is 500° C., roasting time is 60 min, and 5% (w/w) of hydrochloric acid is used for washing once for 30 min at 40° C. and under an ultrasonic condition, the obtained block-shaped material is washed for 20 min by high purity water at a room temperature, to obtain the aluminum alloy scrap without paint and oil.

The block-shaped material is put into a vacuum induction furnace, and rapidly melted, and a spectrometer is used for online-detecting components of aluminum alloy melt liquid, a specific detection result is as shown in Table 2. According to the requirements of the target 2024 aluminum alloy components, a pure copper of which a mass fraction is 2.0% (relative to the aluminum alloy scrap) is weighed, added to the aluminum alloy melt liquid, and melted in a condition of 900° C., a vacuum induction furnace is vacuumized until the internal pressure intensity is less than 15 Pa and the oxygen partial pressure is less than 0.00005 Pa, the electromagnetic induction is used for performing electromagnetic stirring on the melt liquid, a melting dynamic condition is improved, and upward floating of inclusions is accelerated. Zinc and magnesium volatilized in the melting process are liquefied after encountering with a graphite condensing plate above the melt liquid.

After 100 min, a ceramic foam filter is used for filtering the aluminum alloy melt liquid, and then a semi-continuous casting machine is used for casting, to obtain a casting ingot. Chemical components of the casting ingot are detected by ICP-OES, a detection result is as shown in Table 2, and meets the requirements of the 2024 aluminum alloy components in “GB/T3190-2008 wrought aluminum and aluminum alloy chemical components”. Through comparing aluminum alloy weights before and after melting, it is proved that a metal yield is no less than 98.5%.

TABLE 2
Components of aluminum alloy scrap, regenerated 2024 aluminum
alloy and 2024 aluminum alloy (weight percentage)

| | Cu | Zn | Mg | Mn | Cr | Si | Fe |
|---|---|---|---|---|---|---|---|
| Original | 2.69 | 2.58 | 2.55 | 0.67 | 0.05 | 0.35 | 0.12 |
| components | | | | | | | |
| Final | 4.50 | 0.10 | 1.26 | 0.67 | 0.06 | 0.39 | 0.13 |
| components | | | | | | | |
| 2024-Al | 3.80- | <0.25 | 1.20- | 0.30- | <0.10 | <0.50 | <0.50 |
| | 4.90 | | 1.80 | 0.90 | | | |

### Example 3

A suitable amount of 2-series and 7-series aluminum alloy cutting remainders are taken for roasting in the air (oxygen concentration is 21 vol %), a roasting temperature is 550° C., roasting time is 40 min, and 4% (w/w) of hydrochloric acid is used for washing once for 20 min at 60° C. and under an ultrasonic condition, the obtained cutting remainders are washed for 30 min by high purity water at a room temperature, to obtain the aluminum alloy scrap without paint and oil.

Briquetting treatment is performed on the scrap for 3 min at 50 MPa, 35% NaCl-35% KCl-30% AlCl3 (w/w) of molten salt and a block-shaped material are put into a normal pressure intermediate frequency furnace together, and rapidly melted, and a spectrometer is used for online-detecting components of aluminum alloy melt liquid, a specific detection result is as shown in Table 3. According to the requirements of the target 7075 aluminum alloy components, a zinc-magnesium alloy of which a mass fraction is 5.0% (relative to the aluminum alloy scrap) is weighed, added to the aluminum alloy melt liquid, and melted in a condition of 800° C., the pressure intensity is a normal pressure, and the oxygen partial pressure is not additionally controlled, the electromagnetic induction is used for performing electromagnetic stirring on the melt liquid, a melting dynamic condition is improved, and upward floating of inclusions is accelerated.

After 60 min, a ceramic foam filter is used for filtering the aluminum alloy melt liquid, and then a semi-continuous casting machine is used for casting, to obtain a casting ingot. Chemical components of the casting ingot are detected by ICP-OES, a detection result is as shown in Table 3, and meets the requirements of the 7075 aluminum alloy components in “GB/T3190-2008 wrought aluminum and aluminum alloy chemical components”. Through comparing aluminum alloy weights before and after melting, it is proved that a metal yield is no less than 99%.

TABLE 3
Components of aluminum alloy mixed scrap, regenerated 7075
aluminum alloy and 7075 aluminum alloy (weight percentage)

| | Cu | Zn | Mg | Mn | Cr | Si | Fe |
|---|---|---|---|---|---|---|---|
| Original | 1.26 | 1.67 | 1.89 | 0.15 | 0.25 | 0.10 | 0.42 |
| components | | | | | | | |
| Final | 1.21 | 5.31 | 2.67 | 0.10 | 0.26 | 0.13 | 0.44 |
| components | | | | | | | |
| 7075-Al | 1.2- | 5.1- | 2.1- | <0.3 | 0.18- | <0.4 | <0.5 |
| | 2.0 | 6.1 | 2.9 | | 0.28 | | |

### Example 4

A suitable amount of an aluminum alloy block-shaped material of a waste airplane is taken for roasting, oxygen concentration is 13 vol %, a roasting temperature is 450° C., roasting time is 120 min, and 3% (w/w) of hydrochloric acid is used for washing once for 20 min at 80° C. and under an ultrasonic condition, the obtained block-shaped material is washed for 20 min by high purity water at a room temperature, to obtain the aluminum alloy scrap without paint and oil.

35% NaCl-35% KCl-30% AlCl3 (w/w) of molten salt and the block-shaped material are put into a normal pressure intermediate frequency furnace together, and rapidly melted, and a spectrometer is used for online-detecting components of aluminum alloy melt liquid, a specific detection result is as shown in Table 4. According to the requirements of the target 7075 aluminum alloy components, a zinc-magnesium alloy of which a mass fraction is 5.5% (relative to the aluminum alloy scrap) is weighed, added to the aluminum alloy melt liquid, and melted in a condition of 850° C., the pressure intensity is a normal pressure, and the oxygen partial pressure is not additionally controlled, the electromagnetic induction is used for performing electromagnetic stirring on the melt liquid, a melting dynamic condition is improved, and upward floating of inclusions is accelerated.

After 100 min, a ceramic foam filter is used for filtering the aluminum alloy melt liquid, and then a semi-continuous casting machine is used for casting, to obtain a casting ingot. Chemical components of the casting ingot are detected by ICP-OES, a detection result is as shown in Table 4, and meets the requirements of the 7075 aluminum alloy components in “GB/T3190-2008 wrought aluminum and aluminum alloy chemical components”. Through comparing aluminum alloy weights before and after melting, it is proved that a metal yield is no less than 99%.

TABLE 4
Components of aluminum alloy scrap, regenerated 7075 aluminum
alloy and 7075 aluminum alloy (weight percentage)

| | Cu | Zn | Mg | Mn | Cr | Si | Fe |
|---|---|---|---|---|---|---|---|
| Original | 1.87 | 2.46 | 1.01 | 0.22 | 0.20 | 0.25 | 0.14 |
| components | | | | | | | |
| Final | 1.77 | 5.61 | 2.17 | 0.20 | 0.19 | 0.23 | 0.10 |
| components | | | | | | | |
| 7075-Al | 1.2- | 5.1- | 2.1- | <0.3 | 0.18- | <0.4 | <0.5 |
| | 2.0 | 6.1 | 2.9 | | 0.28 | | |

### Example 5

A suitable amount of a mixed material of 2-series and 7-series aluminum alloy processing sweeps and cutting remainders is taken for roasting in the air (oxygen concentration is 21 vol %), a roasting temperature is 400° C., roasting time is 100 min, and 5% (w/w) of hydrochloric acid is used for washing once for 30 min at 50° C. and under an ultrasonic condition, the obtained mixed material is washed for 40 min by high purity water at a room temperature, to obtain the aluminum alloy scrap without paint and oil.

Briquetting treatment is performed on the scrap for 2 min at 50 MPa, a block-shaped material is put into a vacuum induction furnace, and rapidly melted, and a spectrometer is used for online-detecting components of aluminum alloy melt liquid, a specific detection result is as shown in Table 5. According to the requirements of the target 2219 aluminum alloy components, a copper-aluminum alloy of which a mass fraction is 1.0% (relative to the aluminum alloy scrap) is weighed, added to the aluminum alloy melt liquid, and melted in a condition of 850° C., the vacuum induction furnace is vacuumized until the internal pressure intensity is less than 20 Pa and the oxygen partial pressure is less than 0.00005 Pa, the electromagnetic induction is used for performing electromagnetic stirring on the melt liquid, a melting dynamic condition is improved, and upward floating of inclusions is accelerated. Zinc and magnesium volatilized in the melting process are liquefied after encountering with a graphite condensing plate above the melt liquid.

After 100 min, a ceramic foam filter is used for filtering the aluminum alloy melt liquid, and then a semi-continuous casting machine is used for casting, to obtain a casting ingot. Chemical components of the casting ingot are detected by ICP-OES, a detection result is as shown in Table 5, and meets the requirements of the 2219 aluminum alloy components in “GB/T3190-2008 wrought aluminum and aluminum alloy chemical components”. Through comparing aluminum alloy weights before and after melting, it is proved that a metal yield is no less than 99%.

TABLE 5
Components of aluminum alloy mixed scrap, regenerated 2219
aluminum alloy and 2219 aluminum alloy (weight percentage)

| | Cu | Zn | Mg | Mn | Cr | Si | Fe |
|---|---|---|---|---|---|---|---|
| Original | 5.10 | 1.20 | 1.05 | 0.37 | 0.05 | 0.12 | 0.28 |
| components | | | | | | | |
| Final | 5.98 | 0.03 | 0.01 | 0.35 | 0.01 | 0.10 | 0.26 |
| components | | | | | | | |
| 2219-Al | 5.80- | <0.10 | <0.02 | 0.20- | <0.15 | <0.20 | <0.30 |
| | 6.80 | | | 0.40 | | | |

### Comparative Example 1

A specific method of the present comparative example refers to example 1, a difference is that the sweeps are put into a vacuum induction furnace for melting without being pressed into blocks. Other operations are the same as those in example 1.

As a result, the alloy components may meet the 2024 aluminum alloy requirements, but a metal yield is only 67%, which is reduced by no less than 32% compared with the melting after briquetting.

### Comparative Example 2

A specific method of the present comparative example refers to example 2, a difference is that the scrap is put into a vacuum induction furnace for melting without selective oxidation roasting and washing treatment. Other operations are the same as those in example 2.

As a result, the Cr content in alloy components is 1.25%, and does not meet the 2024 aluminum alloy requirements.

### Comparative Example 3

A specific method of the present comparative example refers to example 3, a difference is that roasting pre-treatment is performed on the scrap in an inert gas (oxygen concentration is less than 10 vol %), and the scrap is put into a normal pressure intermediate frequency furnace for melting after washing treatment. Other operations are the same as those in example 3.

As a result, in alloy components, the Cr content is 1.13%, the Ba content is 0.03%, and the Sr content is 0.02%, which does not meet the 7075 aluminum alloy requirements.

### Comparative Example 4

A specific method of the present comparative example refers to example 3, a difference is that molten salt is not added for covering when melting, and other operations are the same as those in example 3.

As a result, alloy components meet the 7075 aluminum alloy requirements, but a metal yield is only 91%, and is less than the metal yield in example 3 (no less than 99%).

According to data of the above examples 1-5 and comparative examples 1-4, it may be observed that, through the method for recycling the aluminum alloy scrap of the present disclosure, the aluminum alloy meeting the requirements of the industry components can be regenerated and prepared in a high metal yield; the aluminum alloy meeting the requirements of the industry components may not prepared in comparative example 2 without selective oxidation roasting and washing treatment; compared with comparative example 1 without briquetting treatment, the metal yield is significantly improved in example 1 with the briquetting treatment; compared with comparative example 3, in example 3, the paint layer and the oil layer on the surface of the aluminum alloy scrap may be adequately oxidized by controlling the oxygen concentration in the selective oxidation roasting process to guarantee that the paint and the oil are completely removed from the aluminum alloy scrap, thereby the aluminum alloy meeting the requirements of the industry components is prepared; and compared with comparative example 4 without adding the molten salt, the metal yield is improved in example 3 in which the molten salt is added.

It may be observed from the above description that the above examples of the present disclosure achieve the following technical effects.

The present application may, through performing the selective oxidation roasting and washing treatment on the aluminum alloy scrap, efficiently remove the paint and the oil in the mild conditions and the simple operations and avoid the burning loss of the aluminum alloy; through the pressure-controlled and oxygen-controlled melting, adequately utilize the alloy components in the aluminum alloy scrap, accurately and efficiently control the contents of the components such as zinc, copper and magnesium and the like in the aluminum alloy scrap, and regenerate and prepare the aluminum alloy meeting the requirements of the industry components; through the condensing and liquefying step, recycle the volatile elements volatilized in the alloy form, not only save the cost, but also avoid the environment from being harmed by the potentially volatile matter. Therefore, the method for recycling the aluminum alloy scrap of the present disclosure achieves the precise and efficient control of the components such as zinc, copper and magnesium and the like in the aluminum alloy scrap through a short-range melting process, and is capable of adequately utilizing the alloy components in the aluminum alloy scrap in the high metal yield, thereby regenerating and preparing the aluminum alloy meeting the requirements of the industry components.

Although an aerospace example is shown, the examples and principles disclosed herein may be applied to other industries, such as the automotive industry, the space industry, the construction industry, and other design and manufacturing industries. Accordingly, in addition to aircraft, the examples and principles disclosed herein may apply to composite structures of other vehicles (e.g., land vehicles, marine vehicles, space vehicles, etc.) and stand-alone structures.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the FIGURES may also exist.

As used herein, the term “approximately” refers to or represent a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

The above is only the preferable examples of the present disclosure, and is not intended to limit the present disclosure. For those skilled in the art, the present disclosure may have various modifications and changes. Any modifications, equivalent replacements, improvements and the like made within the spirit and principle of the present disclosure shall be included in a scope of protection of the present disclosure.

What is claimed is:

1. A method for recycling an aluminum alloy scrap, wherein the method comprises the following steps:
performing selective oxidation roasting and washing treatment on the aluminum alloy scrap, thereby paint-removing and oil-removing to obtain an uncoated aluminum alloy scrap;
melting the uncoated aluminum alloy scrap in a refining furnace to obtain aluminum alloy melt liquid, online-detecting components of the aluminum alloy melt liquid, and adding a metallic copper, a copper alloy, a magnesium alloy or a zinc alloy to the aluminum alloy melt liquid according to requirements of target alloy components, performing pressure-controlled and oxygen-controlled melting through regulating pressure intensity and oxygen partial pressure in the refining furnace and coupling an external-field stirring mode, to obtain refining aluminum alloy melt liquid;
condensing and liquefying volatile elements volatilized in a pressure-controlled and oxygen-controlled melting process to separate from the refining aluminum alloy melt liquid, in the absence of volatile elements, eliminating the condensing and liquefying step;
filtering the refining aluminum alloy melt liquid, to obtain an aluminum alloy melt having target alloy components; and
casting the aluminum alloy melt.

2. The method of claim 1, wherein the aluminum alloy scrap comprises aluminum alloy sweeps, aluminum alloy cutting remainders or a mixture of them,

3. The method of claim 1, further comprising performing briquetting treatment on the uncoated aluminum alloy scrap before melting the uncoated aluminum alloy scrap.

4. The method of claim 1, further comprising adding molten salt according to requirements of the target alloy components in the pressure-controlled and oxygen-controlled melting process.

5. The method of claim 1, wherein a source of the aluminum alloy scrap comprises an aluminum alloy processing scrap or a waste product disassembled aluminum alloy scrap,

6. The method of claim 1, wherein the aluminum alloy scrap is one or more of 2-series aluminum alloy scrap and a 7-series aluminum alloy scrap.

7. The method of claim 1, wherein the aluminum alloy scrap is a mixed scrap formed of one or more of 2-series aluminum alloy scrap and one or more of 7-series aluminum alloy scrap.

8. The method of claim 1, wherein in no less than 10 vol % of oxygen concentration, the selective oxidation roasting is performed.

9. The method of claim 1, wherein in the selective oxidation roasting process, a roasting temperature is controlled within a range from approximately 200° C. to approximately 600° C.

10. The method of claim 1, wherein a roasting time is controlled within a range of 10-180 min.

11. The method of claim 2, wherein a briquetting treatment of the uncoated aluminum alloy scrap is performed by using a briquetting machine and selecting a pressing pressure intensity and a pressing time.

12. The method of claim 2, wherein the pressing pressure intensity is controlled within a range of 10-100 MPa, and a pressing time is controlled within a range of 1-100 min.

13. The method of claim 1, wherein the refining furnace is a vacuum resistance furnace, a vacuum induction furnace or a normal pressure intermediate frequency furnace.

14. The method of claim 1, wherein when a target alloy is a 2-series aluminum alloy, the refining furnace is a vacuum induction furnace.

15. The method of claim 1, wherein when the target alloy is a 7-series aluminum alloy, the refining furnace is the normal pressure intermediate frequency furnace.

16. The method of claim 1, wherein in the pressure-controlled and oxygen-controlled melting process, the pressure intensity in the vacuum induction furnace is controlled to not more than 50 Pa and the oxygen partial pressure in the vacuum induction furnace is controlled to not more than 0.0001 Pa.

17. The method of claim 1, wherein in the pressure-controlled and oxygen-controlled melting process, a melting temperature is controlled within a range of 700-1250° C.

18. The method of claim 1, wherein a melting time is controlled within a range of approximately 10 min to approximately 640 min.

19. The method of claim 1, wherein the external-field stirring mode is electromagnetic stirring or air-blowing stirring.

20. A method for recycling aluminum alloy scrap, the method comprising:
selective oxidation roasting the aluminum alloy scrap;
washing the aluminum alloy scrap to yield an uncoated aluminum alloy scrap;
melting the uncoated aluminum alloy scrap in a refining furnace to yield an aluminum alloy melt liquid;
online-detecting components of the aluminum alloy melt liquid;
adding one or more of metallic copper, copper alloy, magnesium alloy, and zinc alloy to the aluminum alloy melt liquid;
pressure-controlled and oxygen-controlled melting the aluminum alloy melt liquid to yield refining aluminum alloy melt liquid;
filtering the refining aluminum alloy melt liquid to yield an aluminum alloy melt; and
casting the aluminum alloy melt.
